(19) United States
(12) Patent Application Publication
(10) Pub. No.: US 2011/0149582 A1
(43) Pub. Date: Jun. 23, 2011

(54) APPARATUS, METHOD, AND SYSTEM FOR ADJUSTABLY AFFIXING LIGHTING FIXTURES TO STRUCTURES

(75) Inventor: LUKE C. McKEE, OSKALOOSA, IA (US)

(73) Assignee: MUSCO CORPORATION, OSKALOOSA, IA (US)

(21) Appl. No.: 12/910,443

(22) Filed: Oct. 22, 2010

Related U.S. Application Data
(60) Provisional application No. 61/289,239, filed on Dec. 22, 2009.

(51) Int. Cl. F21V 21/00; F16M 13/00

(52) U.S. Cl. 362/382; 248/289.11; 248/278.1

(57) ABSTRACT

Disclosed herein are apparatus, methods, and systems for adjustably affixing an object to a structure via an armature which includes a pivotable knuckle. The armature comprises two assembly components with a set of friction plates compressed therebetween. Said armature is designed to be lightweight (compared to the object), low cost (compared to state of the art adjustable armatures), suitable for outdoor use, and adaptable so to accommodate objects of varying weights, sizes, and form factors without adding significant weight or cost to the overall system.

### CROSS-REFERENCE TO RELATED APPLICATIONS

This application claims priority under 35 U.S.C. §119 to provisional U.S. application Ser. No. 61/289,239, filed Dec. 22, 2009, hereby incorporated by reference in its entirety.

### I. BACKGROUND OF THE INVENTION

The present invention generally relates to the design of a joint which provides adjustability of an object relative to a structure, the joint being part of an adjustable armature which affixes the object to the structure. More specifically, the present invention relates to apparatus and methods whereby a lighting fixture may be affixed to a structure via an armature which includes a knuckle joint such that the lighting fixture may be adjusted and aimed relative to the structure.

The use of knuckle joints to provide a pivot axis for lighting fixtures relative to a structure (typically a cross-arm of a pole) is well known in the art of lighting; see, for example, the knuckle device (reference number 50) disclosed in U.S. Patent Publication No. US 2006/0176708 incorporated by reference herein. Typically, said knuckle joints are designed so to permit pivoting of the lighting fixture about an axis extending through the joint; this is usually facilitated by some form of connective device (e.g., nut and bolt combination) which can be loosened to permit pivoting and then tightened once a preferred orientation (sometimes referred to as an aiming angle) of the lighting fixture is achieved. Some state-of-the-art armatures are further designed to restrict pivoting about the pivot axis to a certain range, though this is not always the case.

In the current state of the art, some designs for armatures which adjustably affix a lighting fixture or other object to a structure suffer from a variety of deficiencies. On the one hand it is not uncommon for a lighting fixture to be bolted or otherwise affixed to a simple armature which is further bolted or otherwise affixed to the structure (sometimes completely omitting the ability to pivot via a knuckle); this uncomplicated design, while functional for some applications, fails to address the needs of outdoor lighting fixtures (e.g., corrosion protection, preventing moisture from adversely affecting the fixtures or components thereof, robustness of design to withstand wind loading, internal channels for routing wiring, etc.). On the other hand it is not uncommon for a lighting fixture to be affixed to a cross-arm or other structure via a highly complex armature which requires extensive machining and/or special processing steps (e.g., broaching, sand blasting, etc.); this is usually necessary when the fixture is large and/or heavy (e.g., metal halide sports lighting fixtures).

To continue to advance the art, there is always a need for lighting fixtures with ever increasing luminous output. In the art of lighting, it is well known that the cost of a pole or other elevating structure—particularly in wide area lighting applications—can meet or exceed the cost of a lighting fixture; therefore, there is also a need to mount as many fixtures as possible on a single pole. Herein lies competing design considerations; for example, if a fixture is made larger so to accommodate larger and/or additional light sources (to achieve more luminous output), then the fixture becomes heavier and the armature must also increase in size and/or include more robust materials so to accommodate the greater loading. However, if an armature becomes too large and/or exotic, it reduces the carrying capacity of the pole and/or becomes too costly to produce. Thus, there is room for improvement in the art.

### II. SUMMARY OF THE INVENTION

As stated, the design of armatures for adjustably affixing an object to a structure is limited by size, weight, and cost considerations, particularly for outdoor lighting fixtures intended to illuminate large areas. The art may benefit from an armature design (also referred to as a knuckle design) which permits adjustability of the object relative to the structure about at least one pivot axis and in a manner that does not significantly increase the size, weight, or cost of the armature as the object becomes larger and/or heavier. Envisioned is an armature including a knuckle comprising simple parts which do not require special processing, the armature being compact in size (relative to the object), adaptable to objects of different sizes and weights, and adapted for outdoor use.

It is therefore a principle object, feature, advantage, or aspect of the present invention to improve over the state of the art and/or address problems, issues, or deficiencies in the art.

An apparatus according to one aspect of the present invention comprises a plurality of stacked discs (also referred to as friction discs or clutch plates) compressed between two armature halves. Said armature halves are brought into operative connection so to provide a pivot axis extending transversely though the assembled armature and through the center of the stacked discs. The armature half in operative connection with a support structure (e.g., pole) is adapted so to provide a second pivot axis extending longitudinally though said armature half and transversely through said pole. The resulting apparatus is one whereby a lighting fixture (or other object) may be affixed to a pole (or other structure), adjusted about either or both pivot axes, and secured in its preferred orientation once adjusted.

A method according to one aspect of the present invention comprises distributing the weight of the object (i.e., directing the loading path) through the stacked clutch plates—the combination of which is designed for a particular coefficient of friction—such that a defined torque on the device connecting the two armature halves (e.g., nut and bolt combination) produces a defined resistance of the armature to movement, the resistance to movement being defined in accordance with anticipated wind loading and size/shape of the object.

These and other objects, features, advantages, or aspects of the present invention will become more apparent with reference to the accompanying specification and claims.

### III. BRIEF DESCRIPTION OF THE DRAWINGS

From time-to-time in this description reference will be taken to the drawings which are identified by figure number and are summarized below.

FIGS. 1A and 1B illustrate an exemplary armature according to the invention affixed to one possible lighting fixture. FIG. 1A illustrates a perspective view and FIG. 1B illustrates an exploded perspective view.

FIGS. 2A-F illustrate various views of a structure half of the armature of FIGS. 1A-B according to aspects of the present invention.

FIGS. 3A-F illustrate various views of a fixture half of the armature of FIGS. 1A-B according to aspects of the present invention.

FIGS. 4A-C and 5A-C illustrate detailed views of the friction discs for use with the armature of FIGS. 1A-3F.

FIG. 6 is an enlarged section view of the assembled armature taken along line A-A of FIG. 1A.

FIG. 7 is an enlarged isolated plan view of the structure half of the armature of FIG. 2C showing how friction discs are restrained against rotation relative to said half.

FIG. 8 is an enlarged isolated plan view of the fixture half of the armature of FIG. 3C showing how friction discs are restrained against rotation relative to said half.

FIG. 9 is an enlarged isolated perspective view showing the relationship of friction discs when installed in the armature.

### IV. DETAILED DESCRIPTION OF EXEMPLARY EMBODIMENTS

### A. Overview

To further an understanding of the present invention, specific exemplary embodiments according to the present invention will be described in detail. Frequent mention will be made in this description to the drawings. Reference numbers will be used to indicate certain parts in the drawings. The same reference numbers will be used to indicate the same parts throughout the drawings unless otherwise indicated.

The general concept of securing a lighting fixture to a cross-arm or other structure via an armature is well known; adapting the armature to provide some degree of adjustability so to facilitate aiming of the lighting fixture is also well known. Of course, it is possible to provide adjustability about a pivot axis according to a variety of apparatus and methods, but if adjustability is to be at will and in situ, often frictional forces are relied upon to hold the lighting fixture in a particular orientation after adjusting.

While the use of friction to establish a defined relationship between two or more surfaces is well known in a variety of arts (e.g., the sport of curling revolves around the frictional forces involved between an object and ice), in the present invention friction is manifested primarily in the interaction between friction discs—though frictional forces exist between any two bodies in contact—for the purposes of joining parts and providing a path for transmitting forces.

Friction, on the whole, is a vague concept unless qualified by a term indicating a particular form of friction (e.g., dry, kinetic, etc.); it is assumed that one of skill in the art is aware of the basic concepts involved with calculating frictional forces and the general role it plays in an adjustable armature which includes a knuckle. Likewise, it is assumed that one of skill in the art is aware of the forces that act on a lighting fixture elevated and mounted to a structure; therefore, discussion of wind loading, form factor, torsion, and the like are omitted from this text.

Simply put, when a lighting fixture is elevated and secured to a cross-arm by an armature designed to be pivotable, there are competing forces. Gravity will attempt to draw the fixture downward whereas wind will attempt to push the fixture in any number of directions; the effects of these forces are directly related to the size, shape, and mass of the fixture. Therefore, to ensure a lighting fixture will remain in a desired position (i.e., at a desired aiming angle) the armature must demonstrate a certain resistance to these forces; this is manifested in everything from the selection of materials to the thickness of parts to how the weight of the fixture is distributed throughout the armature. Further, if the fixture is intended to be adjustable via the armature, the armature must have means or components for providing said adjustability in a manner that does not diminish its resistance to said forces.

According to the present invention, an envisioned exemplary armature comprises two halves; one which is secured to the structure and one which is secured to the fixture. A series of clutch plates are compressed between the two halves and secured by a connective device. In practice, the connective device is loosened and the fixture oriented as desired; according to the present exemplary embodiment the fixture may be oriented via two pivot axes, though this is by way of example and not by way of limitation. After the fixture is oriented as desired the connective device is tightened. When the connective device is tightened a specific amount, the armature demonstrates a specific resistance to movement; this resistance ensures that a fixture of a specific weight and/or form factor (also referred to as a drag coefficient) will sufficiently oppose the aforementioned forces acting upon it and maintain its position. A specific example is given, but it can be appreciated that exemplary apparatus, methods, and systems described herein could be adapted for a variety of objects, anticipated forces, etc.

### B. Exemplary Method and Apparatus Embodiment 1

A more specific exemplary embodiment, utilizing aspects of the generalized example described above, will now be described.

1. System Assembly and Operation—Generally

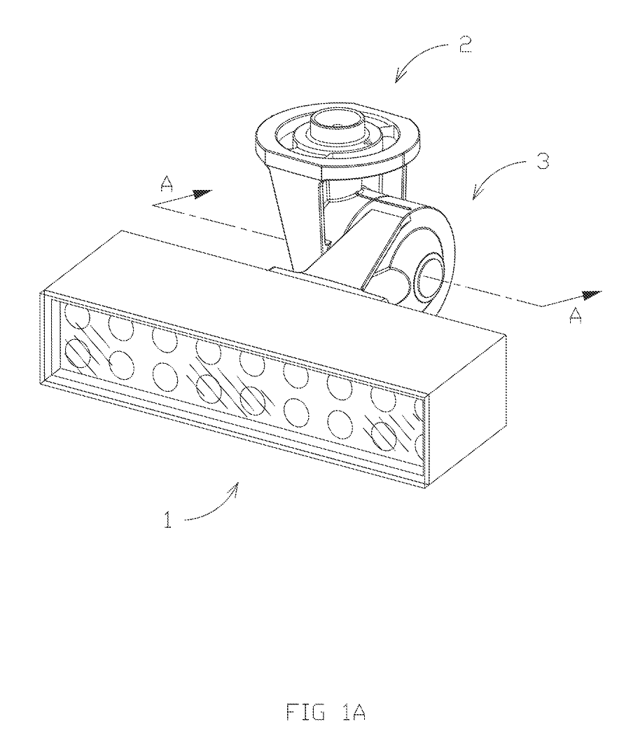

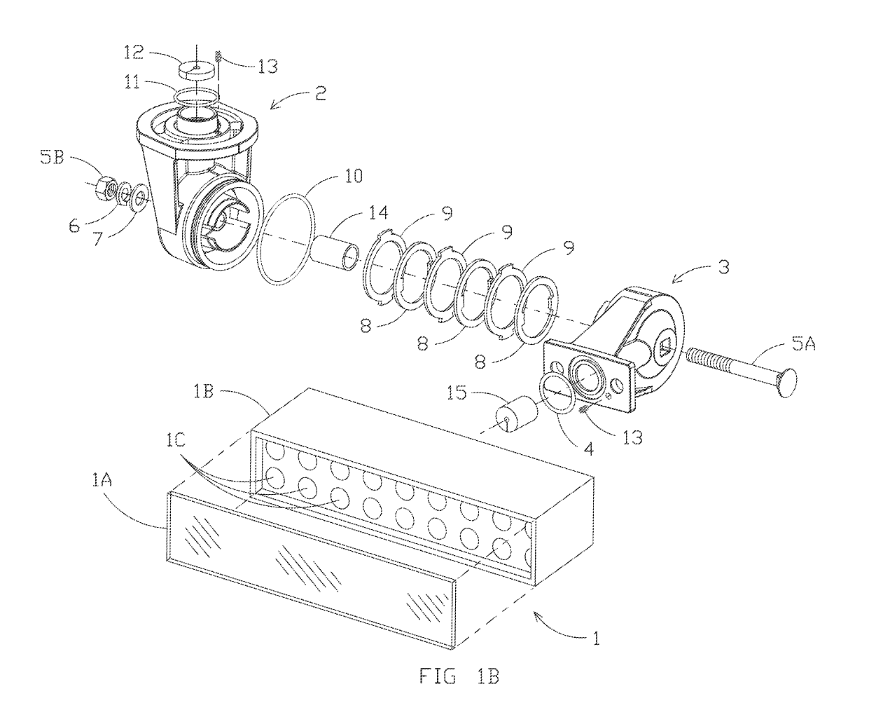

FIGS. 1A and 1B illustrate the use of an adjustable armature according to aspects of the present invention to affix a lighting fixture to a structure (not illustrated). As can be seen from FIGS. 1A and 1B, lighting fixture 1—which generally comprises a housing 1B, light source(s) 1C, and outer lens 1A—is affixed to a fixture knuckle half 3. It is of note that fixture 1 is only generally illustrated and that a variety of fixtures could be used with the exemplary armature; U.S. Patent Publication No. US 2009/0284966, U.S. Patent Publication No. US 2009/0323330, and aforementioned U.S. Patent Publication No. US 2006/0176708, all of which are incorporated by reference herein, illustrate a few possible non-inclusive examples. A structure knuckle half 2 is affixed to a structure (not illustrated) at one end and affixed to fixture knuckle half 3 at the other end via connective device 5 (see connective device parts 5A and 5B in FIG. 1B). The combination of knuckle halves 2 and 3—with associated parts illustrated in FIG. 1B—comprises the exemplary armature.

Wiring (not shown) from lighting fixture 1 may be fed through an aperture in housing 1B into a complementary aperture in fixture knuckle half 3, and further into the body of fixture knuckle half 3. From there, wiring may travel through the body of structure knuckle half 2, out an aperture in structure knuckle half 2, and into a complementary aperture in the structure. A series of sealing members (see reference nos. 10, 11, and 14) ensure wiring and the internal components of knuckle halves 2 and 3 are not exposed to adverse environmental conditions (e.g., moisture). Connective device 5 is isolated from the wiring via integrally formed portions of knuckle halves 2 and 3 so to prevent adverse electrical conditions (e.g., shorting). However, to ensure proper electrical grounding between fixture 1 and the structure, both halves 2 and 3 are designed to include grounding springs 13.

Fixture knuckle half 3 pivots relative to structure knuckle half 2 about an axis extending through the length of connective device 5 (i.e., usually a horizontal axis when installed in operating position). Likewise, structure knuckle half 2 pivots about an axis extending along the length of structure knuckle half 2 (i.e., usually a vertical axis) via its connection to the structure. In this manner, fixture 1 may be aimed relative to the target area in two axes.

A series of friction discs 8 having radially inward extending tabs formed to fit in structure knuckle half 2 are alternated with a series of friction discs 9 having radially outwardly extending tabs formed to fit in fixture knuckle half 3 to provide multiple interfaces to resist pivoting and provide frictional forces. It is of note that when fully assembled, complementary surfaces of knuckle halves 2 and 3 are not flush (see the slight separation in FIG. 1A) so to ensure the loading path travels through the stacked and compressed friction discs.

In practice, when a desired position (i.e., aiming angle) is achieved via pivoting about either or both axes, connective device 5 may be tightened a specified amount which produces in the armature a specific resistance to pivoting of half 3 relative to half 2. In this manner, the number of friction discs 8 and 9 and torque on connective device 5 may be adjusted as needed to provide the frictional forces necessary to hold an object in place relative to a structure. If necessary, the size of and/or material comprising the exemplary armature (or some subset of the components therein) could also be adjusted.

2. System Assembly and Operation—Specifically

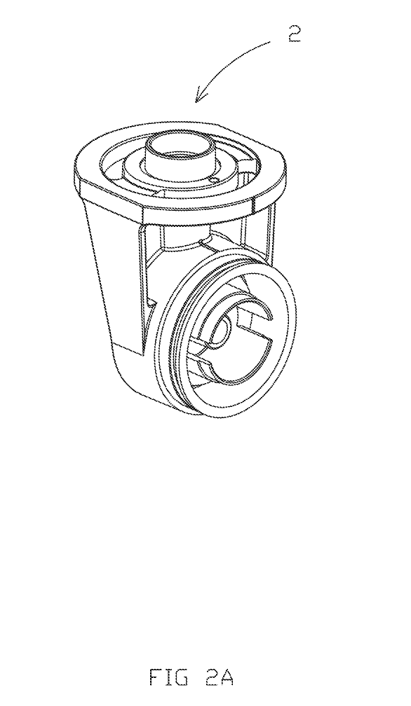

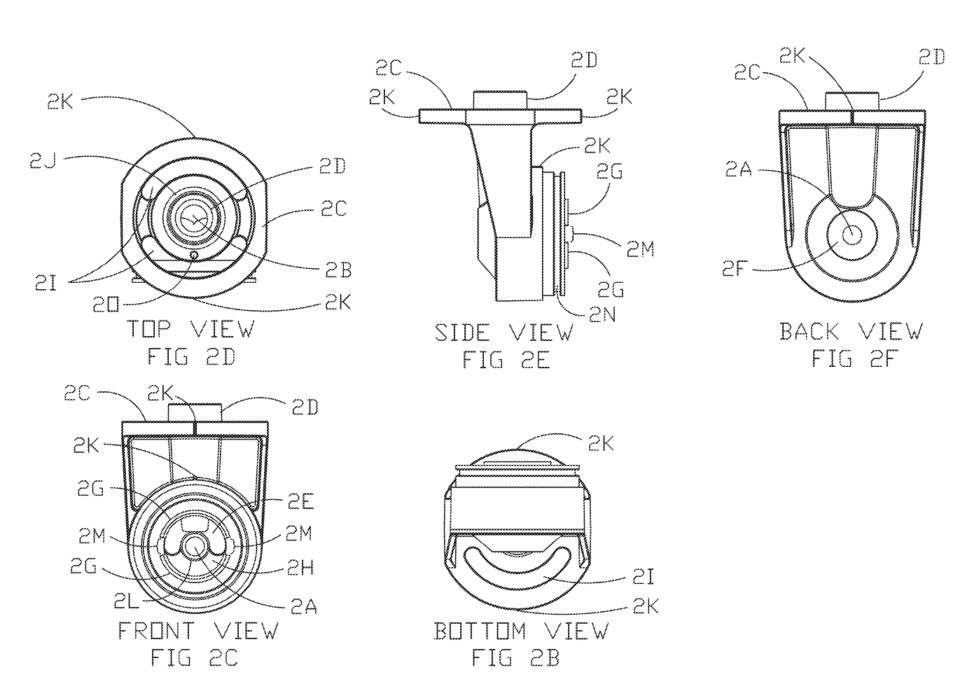

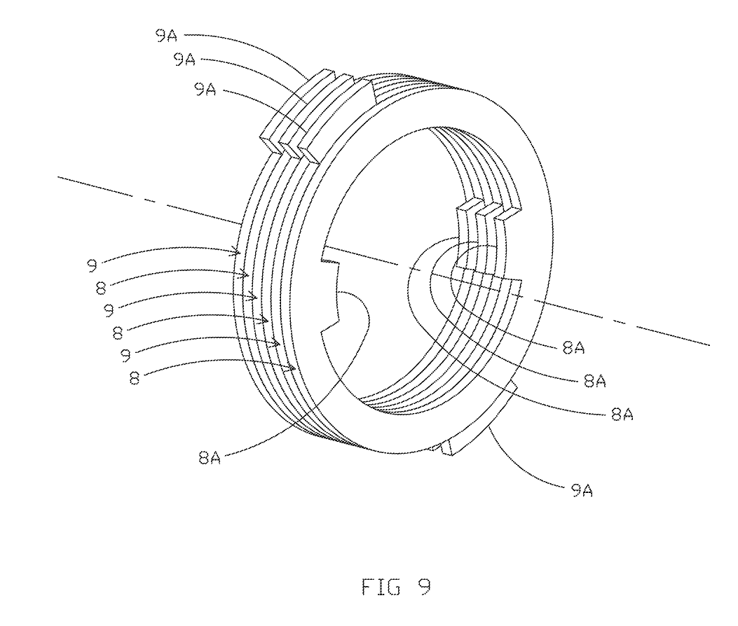

FIGS. 2-9 illustrate in more detail the components of the armature according to aspects of the present invention. As can be seen from FIGS. 2A-F, structure knuckle half 2 comprises a central aperture 2A through which connective device part 5A passes (see FIGS. 1A and 1B). Central aperture 2A extends through knuckle half 2 and is bounded on one end by a formed section 2L (see FIG. 2C) which helps to isolate connective device 5 from internal wiring; as designed formed section 2L is generally conical with a slight taper (e.g., on the order of 3°) so to increase the ease with which sealing member 14 (e.g., a silicone tube) is placed on section 2L (see FIG. 6), though this is by way of example and not by way of limitation. Central aperture 2A is bounded on the other side (see FIG. 2F) by a flat surface 2F which helps to distribute the stress imparted by connective device 5 when parts 5A and 5B are tightened; a split washer 6 (FIG. 1B) helps to ensure parts 5A and B stay in operative connection and at the appropriate torque, and an optional flat washer 7 (FIG. 1B) helps to ensure washer 6 does not mar knuckle half 2.

Knuckle half 2 further comprises an internal channel which runs from aperture 2B (see FIG. 2D) along the length of half 2 to groove 2E (see FIG. 2C) for the passing of wiring (or other components). As can be seen, groove 2E is taken in surface 2H and is bounded by formed section 2G and formed section 2L; the radially inward projecting tabs 8A of rings 8 (see FIGS. 5A-C, 7, and 9) are positioned in gaps 2M between formed sections 2G. This ensures that wiring is isolated from connective device 5, and that both wiring and connective device 5 are not in the load path being transmitted through stacked rings 8 and 9. To further ensure that the load path is transmitted primarily through stacked rings 8 and 9, sealing member 10 is placed in channel 2N (see FIG. 2E) and compressed between outermost radial portions of halves 2 and 3 (see FIGS. 1A and B).

Knuckle half 2 further comprises a formed section 2D which bounds aperture 2B and extends into a complementary aperture in the structure such that surface 2C sits flush with at least a portion of the outer surface of the structure, thus compressing sealing member 11 (FIG. 1B) in channel 2J and grounding spring 13 (FIG. 1B) in blind hole 2O. An optional disc 12 (FIG. 1B) could be seated in aperture 2B (see FIG. 6) to act both as a guide for wiring entering the structure and to prevent slag, water, or the like from seeping into the armature; optional disc 12 could be of any compressible, non-conductive material (e.g., a simple foam disc cut from stock).

Connective devices (not illustrated, but may be similar in nature to connective device 5) through apertures 21 and into the structure may positionally affix structure knuckle half 2 to the structure. Said connective devices could be loosened—but not fully removed—such that knuckle half 2 may be pivoted about an axis along the length of the connective devices and knuckle half 2 (i.e., a vertical axis) while still affixed to the structure; in this manner, formed section 2D helps define the center of rotation of knuckle half 2 relative to the structure. The degree to which the armature may pivot about a vertical axis is defined by the size of apertures 2I (e.g., the longitudinal length of their arc shapes); in this example, the armature may pivot about a vertical axis on the order of 90°, though this is not by way of limitation. The amount of pivot is generally indicated by markings 2K (distributed along outer surfaces of half 2 generally correlated to different positions along apertures 21 or to rotational positions between halves 2 and 3) which help to track both the position of structure knuckle half 2 relative to the structure and halves 2 and 3 relative to each other (see also markings 3K on knuckle half 3).

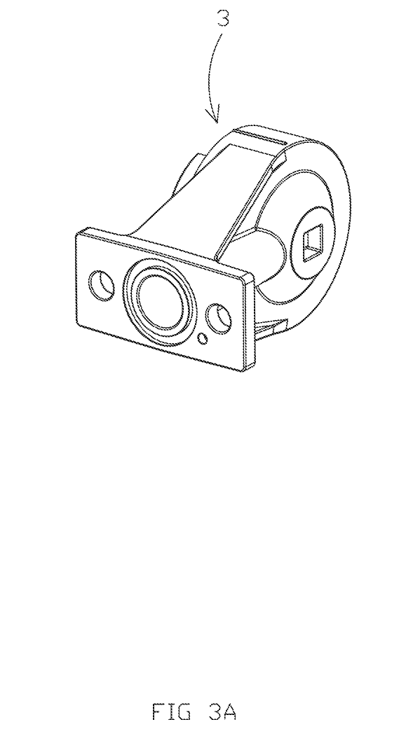

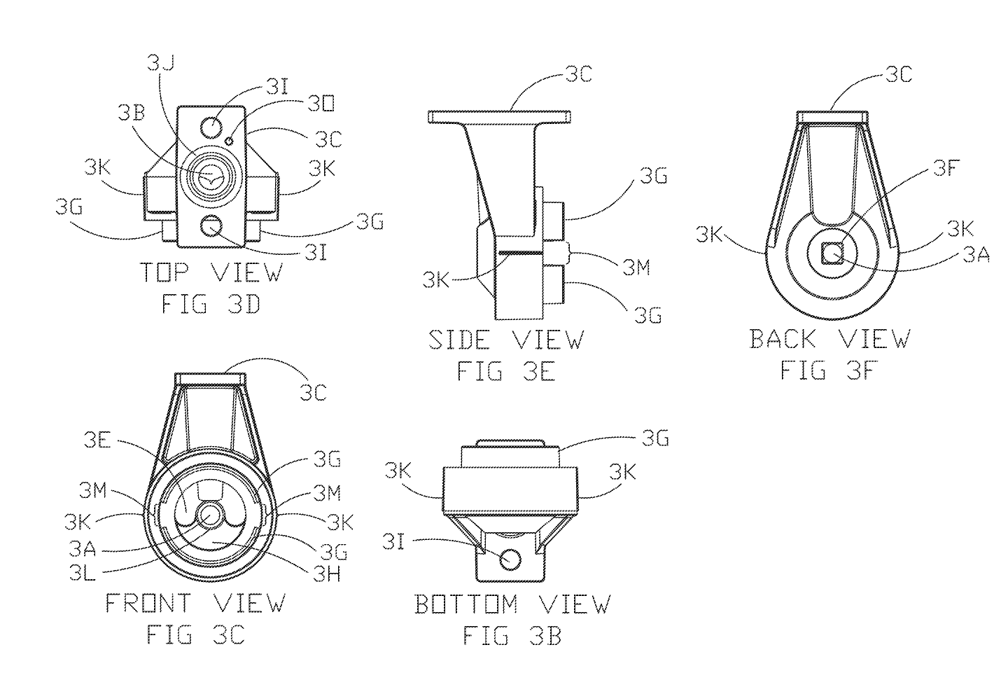

Fixture knuckle half 3 is designed to be complementary to structure knuckle half 2. As can be seen from FIGS. 3A-F, knuckle half 3 comprises a slightly tapered central formed section 3L which bounds an aperture 3A through which connective device portion 5A passes; again, the slight taper is to aid in the placement of sealing member 14 (see FIG. 6), though this is by way of example and not by way of limitation. Aperture 3A is bounded on the other side of knuckle half 3 by groove 3F (see FIG. 3F); as designed, connective device portion 5A in this exemplary embodiment is a ½″ stainless steel carriage bolt to ensure both corrosion protection and one-hand tightening of connective device 5 when the head of portion 5A is seated in groove 3F (see FIG. 1A), though this is by way of example and not by way of limitation.

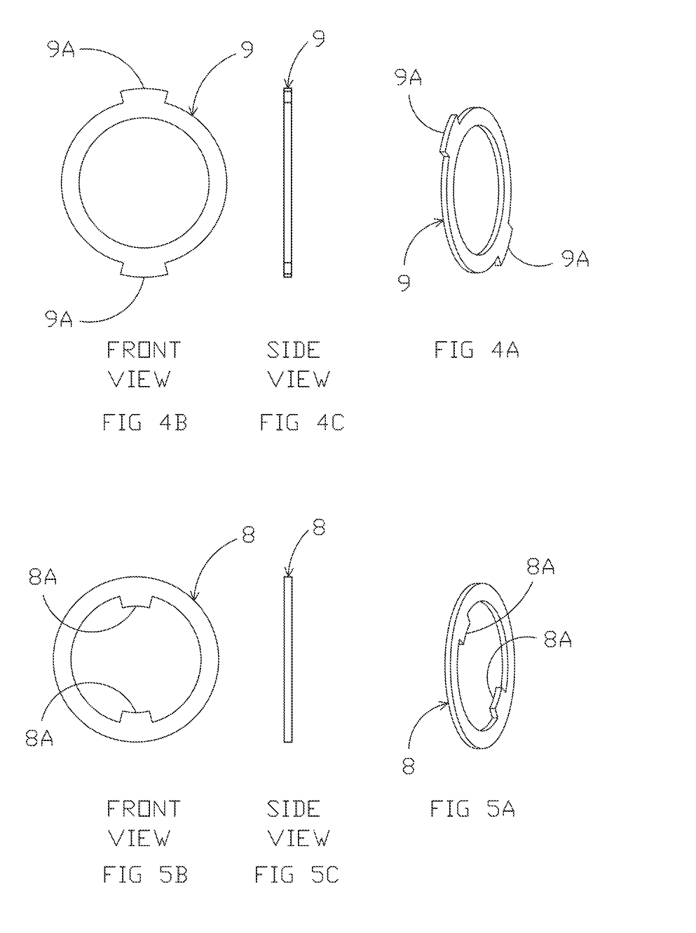

Knuckle half 3 further comprises an internal channel running from aperture 3B to groove 3E for the passing of wiring or other objects. As can be seen, groove 3E is taken in surface 3H and is bounded by formed and slightly tapered sections 3G and 3L; the radially outward projecting tabs 9A of rings 9 (see FIGS. 4A-C, 8, and 9) are positioned in gaps 3M between sections 3G. Like structure knuckle half 2, this ensures that wiring is isolated from connective device 5, and that both wiring and connective device 5 are not in the load path being transmitted through stacked rings 8 and 9.

One difference between knuckle halves 2 and 3 is that fixture knuckle half 3 does not have a formed section projecting from surface 3C as does structure knuckle half 2 (see reference no. 2D), though a member 15 similar in function to disc 12 (see FIG. 1B) is still included. A projecting surface has been omitted from surface 3C primarily so that fixture knuckle half 3 may be affixed to a variety of different objects; for example, while most cross-arms are hollow and can accommodate projection 2D, some fixtures are so densely packed with light sources and optical elements that there would be no room for a similar projection from surface 3C. As such, knuckle half 3 is affixed to a fixture 1 via connective devices (not illustrated, but may be similar in nature to connective device 5) through apertures 3I such that surface 3C sits flush with at least a portion of the outer surface of the fixture, thus compressing sealing member 4 (FIG. 1B) in channel 3J and grounding spring 13 (FIG. 1B) in blind hole 30; however, if space allowed, a projection similar to 2D could be included in knuckle half 3. As another option, apertures 3I could be offset from each other (e.g., near opposing corners of surface 3C) so to aid in reducing any moment about aperture 3B (e.g., due to wind loading).

In practice, connective device portions 5A and B could be loosened—but not fully removed—such that knuckle half 3 may be pivoted about an axis along the length of the connective device 5 (i.e., generally a horizontal axis) while still affixed to knuckle half 2. The degree to which knuckle half 3 may pivot about a horizontal axis is defined by the size/shape of the fixture affixed to knuckle half 3 and the size/shape of the structure affixed to knuckle half 2; in practice, it is not likely one would need more than approximately 180° of rotation about a horizontal axis to adequately aim a lighting fixture.

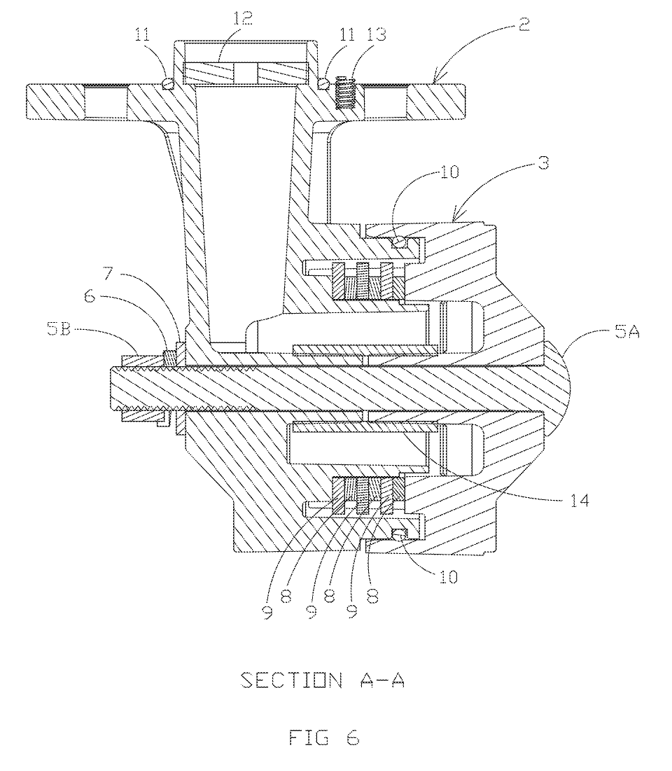

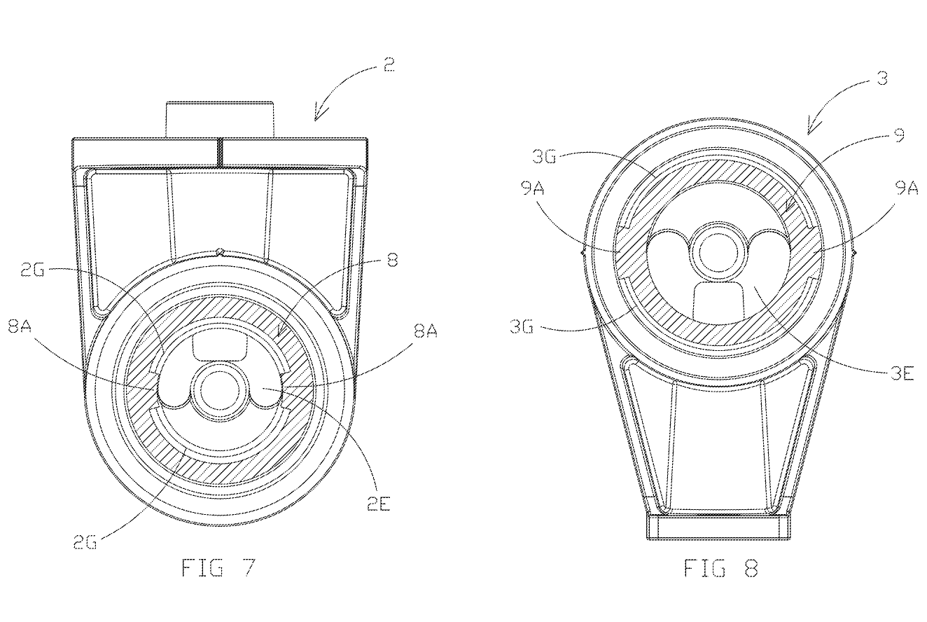

FIGS. 4A-C and 5A-C illustrate clutch plates 9 and 8, respectively. FIGS. 7 and 8 illustrate how said clutch plates—shown hatched for clarity—are positionally affixed in knuckle halves 2 and 3, thus ensuring that no load is inadvertently transferred to halves 2 and 3 via rotation or lateral movement of plates 8 and 9 and that the torque on connective device 5 translates to a compressive force on discs 8 and 9. As envisioned, clutch plates 8 and 9 are stamped or otherwise machined from sheet material; in this example an aluminum alloy (e.g., Aluminum 5052-H32), though other materials (e.g., brass, steel, etc.) may be used. Parts fabricated in this fashion are typically deburred via a tumbling process before further machining or coating. While clutch plates that are deburred and smoothed to provide a mill finish could be used in the present invention, if said plates are tumbled—but not subjected to further finishing processes typical in the art—it has been discovered that the surface of plates 8 and 9 are sufficiently rough so to increase the coefficient of friction but not so roughened as to significantly diminish the structural integrity of the plates. Table 1 illustrates a comparison of finished plates (i.e., smooth surface with a mill finish) and tumbled plates.

TABLE 1

| | Finished Clutch Plates | | Tumbled Clutch Plates | |
|---|---|---|---|---|
| Weight of Light Fixture | 65 | lbs | 65 | lbs |
| Number of Clutch Plates | 6 | | 6 | |
| Torque on Connective | 50 | ft-lbs_{f} | 50 | ft-lbs_{f} |
| Device 5 | | | | |
| Resistance of Armature | 150 | ft-lbs_{f} | 385 | ft-lbs_{f} |
| to Pivot | | | | |

So it can be seen from Table 1 that it is can be beneficial to use tumbled friction discs in the envisioned armature because it does not add cost to the system (since parts produced in this manner are tumbled as a course of action) and increases the resistance of the armature to pivot (compared to the finished friction discs). However, it is of note that either finished or tumbled discs (or some combination thereof) could be used in the envisioned armature; namely, because adding discs of either kind to the envisioned armature is a non-complex and low cost way to increase the load capacity of the armature without adding significant bulk to the overall system. Additionally, either finished clutch plates or tumbled clutch plates could be anodized to aid in corrosion resistance, as it has been found that this process does not dramatically alter the coefficient of friction.

### C. Options and Alternatives

The invention may take many forms and embodiments. The foregoing examples are but a few of those. To give some sense of some options and alternatives, a few examples are given below.

A variety of connective devices, sealing members, and positioning members are described and illustrated herein. Though specific examples are given (e.g., a silicone tube) the present invention is not limited to such. For example, instead of a threaded bolt and nut combination, a connective device could comprise a clamp, dowel/hole, or latch-type device. As another example, instead of an o-ring, a sealing member could be omitted and parts welded together. Any number of devices which aid in adjustably affixing an object to a structure via a pivotable armature could be used and not depart from at least some aspects of the present invention.

Further, the object need not be a lighting fixture and the structure need not be a cross-arm; the size of the armature and the number of friction discs (and/or the materials comprising the friction discs) could be altered in accordance.

What is claimed is:

1. An assembly for adjustably affixing an object to a structure comprising:
a. a structure mounting section adapted at one portion for operative connection with the structure and adapted at a different portion for operative connection with an object mounting section;
b. the object mounting section adapted at one portion for operative connection with the object and adapted at a different portion for operative connection with the structure mounting section.
c. a plurality of friction discs between the structure mounting section and object mounting section and with adjacent sides of the friction discs in abutment.

2. The assembly of claim 1 wherein the plurality of friction discs are compressed between the structure mounting section and the object mounting section.

3. The assembly of claim 2 further comprising a connective device which extends through the plurality of friction discs and is adapted to keep the structure mounting section and the object mounting section in operative connection.

4. The assembly of claim 3 wherein the connective device provides an axis about which at least a portion of the assembly may pivot.

5. The assembly of claim 1 wherein the structure comprises a cross-arm and the object comprises a lighting fixture.

6. The assembly of claim 5 wherein the armature is adapted to isolate wiring from the lighting fixture from environmental conditions.

7. The assembly of claim 1 further comprising an axis extending transversely through the structure and longitudinally through the structure mounting section about which at least a portion of the assembly may pivot.

8. The assembly of claim 1 further comprising internal pathways in the object mounting section and the structure mounting section such that wiring or other devices may pass from the object to the structure via the assembly.

9. A method of positioning an object relative to a structure comprising:
a. affixing a portion of an assembly to the object and a separate portion of the armature to the assembly;
b. bringing the two portions of the assembly into proximity such that the two portions encase a plurality of friction discs;
c. pivoting the object portion of the assembly about a pivot axis; and
d. compressing the friction discs between the two portions a specified amount so to create a specified resistance of the assembly to further pivoting.

10. The method of claim 9 whereby compressing the friction discs does not bring the two portions into abutment.

11. The method of claim 9 further comprising alternating a subset of the friction discs with another subset of friction discs.

12. The method of claim 9 further comprising processing the friction discs prior to encasement in the assembly so to produce a specified coefficient of friction.

13. The method of claim 9 wherein the specified amount of compression of the friction discs is determined at least in part by the number of friction discs and the drag coefficient of the object.

14. The method of claim 9 further comprising pivoting the structure portion of the assembly about a second pivot axis.

15. The method of claim 14 wherein the first and second pivot axes are orthogonal.

16. An assembly for mounting an object to a supporting structure but allowing pivoting translation of the object relative to the support structure along a pivot of axis, comprising:
a. two assembly components;
b. a set of friction plates compressed between the two assembly components along the pivot axis.

17. The assembly of claim 16 wherein the friction plates comprise discs with opposite sides comprising friction surfaces.

18. The assembly of claim 16 wherein a first assembly component comprises:
(i) a body; and
(ii) a mounting interface adapted for mounting to a supporting structure.

19. The assembly of claim 18 wherein a second assembly component comprises:
(i) a body; and
(ii) a mounting interface adapted for mounting to an object.

20. The assembly of claim 16 wherein alternating adjacent friction plates are held against rotation relative to alternating said assembly components.

21. The assembly of claim 20 wherein the friction plates are held against rotation by extensions adapted to fit receivers in a said assembly component.
